(19) United States
(12) Patent Application Publication
(10) Pub. No.: US 2018/0111293 A1
(43) Pub. Date: Apr. 26, 2018

(54) METHOD OF MANUFACTURING CURED RESIN FILM

(71) Applicant: ZEON CORPORATION, Chiyoda-ku, Tokyo (JP)

(72) Inventors: Jyou KONAGAWA, Tokyo (JP); Masahumi KAWASAKI, Tokyo (JP)

(21) Appl. No.: 15/500,929

(22) PCT Filed: Sep. 30, 2015
(86) PCT No.: PCT/IB2015/002112

§ 371 Date: Oct. 5, 2017

(30) Foreign Application Priority Data
Jul. 31, 2014 (JP) 2014-156432

(51) Int. Cl. B29C 35/02; B29C 35/00; C08J 5/18; B29C 71/02; C08K 3/013; B32B 7/06; B32B 27/20; F26B 15/00

(52) U.S. Cl. CPC B29C 35/02; B29C 35/002; C08J 5/18; C08J 7/08; B29L 2031/3425; B32B 7/06; B32B 27/20; F26B 15/00; C08K 3/013

(57) ABSTRACT

[Problem] To provide a manufacturing method with which a cured resin film can be manufactured at high yield, and which effectively prevents the occurrence of defects such as wrinkles in the cured resin film.

[Solution] Provided is a cured resin film manufacturing method comprising: a first step in which an undried resin film is formed on a support, the undried resin film comprising a heat curable resin composition containing a curable resin and a solvent; a second step in which a curable resin film having a loss of 0.5-7 wt % on heating is formed by drying the undried resin film which has been formed on the support by using a float method to convey the undried resin, which is in the state of having been formed on the support, in a drying device; a third step in which a cured resin film is formed by heat curing the curable resin film; and a fourth step in which the support is detached from the cured resin film.

### TECHNICAL FIELD

The present invention relates to a manufacturing method of a cured resin film.

### BACKGROUND ART

Along with pursuing downsizing, multifunctionalization, increasing communication speeds, and the like of electronic equipment, further densification of the circuit hoard used in electronic equipment is required, and multilayering of circuit boards is being achieved to meet the requirements of densification. The multilayer circuit board is formed, for example, on an inner layer substrate made of an electrical insulating layer and a conductor layer formed on a surface of the electrical insulating layer, by laminating an electrical insulating layer and forming a conductor layer on the electrical insulating layer, and further repeating laminating the electrical insulating layers and forming the conductor layers.

For example, Patent Literature 1 discloses a technique using a thermosetting resin composition containing a polyamide resin, an epoxy resin having a specific skeleton, and an epoxy resin curing agent, as a thermosetting resin composition for forming an electrical insulating layer for forming the multilayer circuit board. The Patent literature 1 describes a point where a solution of the thermosetting resin composition using a dimethyl formamide as a solvent is obtained, coated onto a release PET film such that the thickness after drying is 25 μm using a comma coater, and then dried for 15 minutes by a floating drying furnace set at 130° C. to form a layer of the thermosetting resin composition.

### CITATION LIST

### Patent Literature

Patent Literature 1: WO 2009/028170

### SUMMARY OF INVENTION

### Problem to be Resolved by the Invention

In actuality, as a result of studies by the present inventors, the technique described in the Patent Literature 1 has problems where the layer of the thermosetting resin composition alter drying using the technique of the Patent Literature 1 is mechanically brittle, and when curing is performed with the release PET film still attached, shrinking is high during curing, and thus defects such as wrinkles occur, and therefore, the obtained electrical insulating layer does not always have sufficient reliability.

An object of the present invention is to provide a manufacturing method that can manufacture with high productivity a cured resin film where defects such as wrinkles or bubbles are effectively preventing from occurring.

### Means for Resolving Problems

As a result of extensive studies in order to achieve the aforementioned object, the present inventors discovered that in order to manufacture with high productivity a cured resin film where defects such as wrinkles or bubbles are effectively prevented from occurring, an undried resin film formed from a thermosetting resin composition containing a cured resin film and solvent is preferably formed on a supporting body, and when the film is dried, a drying method by a floating system is preferably used, and when drying by the floating system, the heating loss amount must be within a specific range, thereby reaching completion of the present invention.

In other words, the present invention provides:

(1) A manufacturing method of a cured resin film, including: a first step of forming on a supporting body an undried resin film formed from a thermosetting resin composition containing a curable resin and solvent; a second step of drying the undried resin film formed on the supporting body by transporting in a floating system in a drying device in a condition formed on the supporting body to obtain a curable resin film with a heating loss amount of 0.5 to 7 wt. %; a third step of thermal curing the curable resin film to obtain a cured resin film; and a fourth step of peeling the supporting body from the cured resin film;

(2) The manufacturing method of a cured resin film according to the aforementioned (1), wherein in the second step, drying is performed by transporting the undried resin film in a condition formed on the supporting body in a floating system in a drying device provided with a heating zone set at 30 to 60° C., and a drying zone set at a higher temperature than the heating zone in this order, the drying time of the undried resin film is set to 30 to 300 seconds, and the drying air flowrate during drying is set at 0.5 to 7 m³/hour;

(3) The manufacturing method of a cured resin film according to the aforementioned (2), wherein the heating zone and drying zone are divided into a plurality of regions, and the temperature of each zone is set to a temperature that gradually increases based the advancement of the undried resin film;

(4) The manufacturing method of a cured resin film according to any one of the aforementioned (1) to (3), wherein a film provided with a release layer on a surface is used as the supporting body;

(5) The manufacturing method according to any one of the aforementioned (1) to (4) wherein the amount of the solvent in the thermosetting resin composition is 5 to 40 wt. %;

(6) The manufacturing method of a cured resin film according to any one of the aforementioned (1) to (5), wherein the thermosetting resin composition further contains an inorganic filler, and the content ratio of the inorganic filler in the thermosetting resin composition is 60 wt. % or greater, calculated as solid content;

(7) The manufacturing method of a cured resin film according to any one of the aforementioned (1) to (6), further including: a second curable resin film forming step of forming on a supporting body a second curable resin film containing a second curable resin that is different from the aforementioned curable resin, prior to the first step; wherein in the first step, the undried resin film is formed on the second curable resin film formed on the supporting body;

(8) The manufacturing method of a cured resin film according to the aforementioned (7), wherein the second curable resin film forming step, including: a step of forming on the supporting body the second undried resin film formed from a second thermosetting resin composition containing the second curable resin and solvent; and a step of drying the second undried resin film formed on the supporting body by transporting in a floating system in a drying device in a condition formed on the supporting body to obtain the second curable resin film with a heating loss amount of 0.5 to 7 wt. %; and p (9) A laminate body, including the cured resin film obtained by the manufacturing method according to arty one of the aforementioned (1) to (8), and a substrate.

### Effect of the Invention

According to the manufacturing method of the present invention, a cured resin film where defects such as wrinkles or bubbles are effectively prevented from occurring can be manufactured with high productivity.

### BRIEF DESCRIPTION OF THE DRAWING

FIG. 1 is a diagram illustrating an example of a manufacturing device used in the present invention.

### DESCRIPTION OF EMBODIMENTS

### Manufacturing Method of a Cured Resin Film

First, the manufacturing method of the present invention will be described.

The manufacturing method of the present invention includes:

a first step of forming on a supporting body an undried resin film formed from a thermosetting resin composition containing a curable resin and solvent;

a second step of drying the undried resin film formed on the supporting body by transporting in a floating system in a drying device in a condition formed on the supporting body to obtain a curable resin film with a heating loss amount of 0.5 to 7 wt. %;

a third step of thermal curing the curable resin film to obtain a cured resin film; and

a fourth step of peeling the supporting body from the cured resin film.

### First Step

The first step of the manufacturing method of the present invention is a step of forming on a supporting body an undried resin film formed from a thermosetting resin composition containing a curable resin and solvent.

The supporting body used in the first step of the manufacturing method of the present invention is not particularly limited, hut include film members, plate members, or the like, and specific examples include polyethylene terephthalate films, polypropylene films, polyethylene films, polycarbonate films, polyethylene naphthalate films, polyarylate films, nylon films, polytetrafluoroethylene films, and other polymer films, plate or film glass substrates, and the like. In order to make peeling from the cured resin layer easier, in the fourth step described later, the supporting body preferably has a release layer formed on a surface thereof by a release treatment, in particular, when forming a via hole or through hole by irradiating a laser from a supporting body side in a condition where the supporting body is provided, a polymeric film having a release layer is preferable, and a polyethylene terephthalate film having a release layer is more preferable, from the perspective of favorably forming a via hole or through hole.

The thickness of the supporting body used in the first step is not particularly limited, but is preferably 5 to 200 μm, more preferably 10 to 150 μm, and even more preferably 20 to 60 μm. By using a supporting body with a thickness within the aforementioned range, the workability the undried resin film formed on the supporting body can be favorable.

Furthermore, the thermosetting resin composition used in the present invention contains a curable resin find solvent, and usually contains a curing agent, in addition thereto. The curable resin is not particularly limited so long as the curable resin exhibits thermal curability when combined with the curing agent and has electrical insulating properties, and examples include epoxy resins, maleimide resins, (meth)acrylic resins, diallyl phthalate resins, triazine resins, alicyclic olefin polymers, aromatic polyether polymers, benzocyclobutene polymers, cyanate ester polymer polyimides, and the like. The resins may be used independently or in a combination of two or more types.

A case of using an epoxy resin as the curable resin is described below as an example.

The epoxy resin is not particularly limited, and for example, a polyvalent epoxy compound (A) with a biphenyl structure and/or a condensed polycyclic structure find the like can be used. The polyvalent epoxy compound (A) with a biphenyl structure and/or condensed polycyclic structure (hereinafter may be abbreviated as polyvalent epoxy compound (A)) is a compound having at least one biphenyl structure or condensed polycyclic structure, and having at least two epoxy groups (oxirane ring) in one molecule.

The biphenyl structure refers to a structure wherein two benzene rings are connected by a single bond. The biphenyl structure in the obtained cured resin usually configures a main chain in the resin, but can be present in a side chain.

Furthermore, the condensed polycyclic structure refers to a structure formed by condensation of two or more monocyclic groups. The ring that configures the condensed polycyclic structure may be alicyclic or aromatic, and may contain a hetero atom. The number of condensed rings is not particularly limited, but is preferably 2 rings or more, and practically, the upper limit is approximately 10 rings from the perspective of increasing heat resistance and mechanical strength of the obtained cured resin layer. Examples of the condensed polycyclic structure include dicyclopentadiene structures, naphthalene structures, fluorene structures, anthracene structures, phenanthrene structures, triphenylene structures, pyrene structures, ovalene structures, and the like. Similar to the biphenyl structure, the condensed polycyclic structure in the obtained cured resin usually configures a main chain in the resin contained in the cured resin layer, but can be present in a side chain.

The polyvalent epoxy compound (A) used in the present invention has a biphenyl structure, condensed polycyclic structure, or both biphenyl structure and condensed polycyclic structure, but from the perspective of increasing heat resistance and mechanical strength of the obtained cured resin layer, the polyvalent epoxy compound (A) preferably has a biphenyl structure, and more preferably has a biphenyl aralkyl structure.

Furthermore, if a polyvalent epoxy compound (A) with a biphenyl structure (includes polyvalent epoxy compounds having both a biphenyl structure and a condensed polycyclic structure) and a polyvalent epoxy compound (A) with a condensed polycyclic structure are used in combination, from the perspective of improving heat resistance and electrical properties of the cured resin layer, the compounding ratio thereof is preferably a weight ratio (polyvalent epoxy compound having a biphenyl structure/polyvalent epoxy compound having a condensed polycyclic structure) of usually 3/7 to 7/3.

The polyvalent epoxy compound (A) used in the present invention has at least two epoxy groups in one molecule, and the structure thereof is not limited as long as the compound has a biphenyl structure and/or a condensed polycyclic structure, but from the perspective of the cured resin layer having excellent heat resistance and mechanical strength, the compound is preferably a novolak epoxy compound having a biphenyl structure and/or a condensed polycyclic structure. Examples of the novolak epoxy compound include phenol novolak epoxy compounds, cresol novolak epoxy compounds, and the like.

In order to achieve good curing reactivity, the polyvalent epoxy compound (A) usually has an epoxy equivalent of 100 to 1500 equivalents, and preferably 150 to 500 equivalents. Note that “epoxy equivalent” in the present specification is the number of grams (g/eq) of the epoxy compound containing 1 gram equivalent of an epoxy group, which can be measured according to a method of JIS K 7236.

The polyvalent epoxy compound (A) used in the present invention can be appropriately manufactured according to a known method, and can also be obtained as a commercially available product. Examples of the commercially available product of the polyvalent epoxy compound (A) having a biphenyl structure are novolak epoxy compounds having a biphenyl aralkyl structure such as trade name “NC3000-FH, NC3000-H, NC3000, NC3000-L, NC3100” (manufactured by Nippon Kayaku Co., Ltd,); epoxy compounds having a tetramethylbiphenyl structure such as trade name “YX-4000” (manufactured by Mitsubishi Chemical Corporation); and the like. Furthermore, examples of the commercially available product of the polyvalent epoxy compound having a condensed polycyclic structure include novolak epoxy compounds having a dicyclopentadiene structure, such as trade name “Epiclon HP7200L, Epiclon HP7200, Epiclon HP7200H, Epiclon HP7200HH, Epiclon HP7200HHH” (“Epiclon” is a registered trademark, manufactured by DIC Corporation), trade name “Tactix 556, Tactix 756” (“Tactix” is a registered trademark, manufactured by Huntsman Advanced Materials), trade name “XD-1000-1L, XD1000-2L” (manufactured by Nippon Kayaku Co., Ltd.), and the like. The polyvalent epoxy compounds (A) can be used independently or in a combination of two or more types.

Furthermore, when using the polyvalent epoxy compound (A) having a biphenyl structure and/or a condensed polycyclic structure, an epoxy compound (B) containing a trivalent or higher polyvalent glycidyl group other than the aforementioned phenol novolak epoxy compound may be used in a combination, and by further using the epoxy compound (B) containing a trivalent or higher polyvalent glycidyl group, heat resistance or electrical properties of the obtained cured resin layer can be further improved.

The epoxy compound (B) containing a trivalent or higher polyvalent glycidyl group other than the phenol novolak epoxy compound is preferably a compound with an epoxy equivalent of 250 or less, and more preferably a compound with 220 or less, from the perspective of heat resistance and electrical properties of the obtained cured resin layer.

Specific examples include: polyvalent phenol epoxy compounds having a structure where a hydroxyl group of the trivalent or higher polyvalent phenol is glycidylated, glycidyl amine epoxy compounds where an amino group of a compound containing a divalent or higher polyvalent aminophenyl group is glycidylated, compounds containing a polyvalent glycidyl group where a trivalent or higher compound having the phenol structure or aminophenyl structure in the same molecule is glycidylated, and the like.

The polyvalent phenol epoxy compound having a structure where a hydroxyl group of the trivalent or higher polyvalent phenol is glycidylated is not particularly limited, but is preferably a trivalent or higher polyvalent hydroxyphenylalkane epoxy compound. Here, the trivalent or higher polyvalent hydroxyphenylalkane epoxy compound is a compound having a structure where a hydroxyl group of an aliphatic hydrocarbon substituted with three or more hydroxyphenyl groups.

The epoxy compound (B) containing a trivalent or higher polyvalent glycidyl group used in the present invention can be appropriately manufactured according to a known method, and can also be obtained as a commercially available product.

Examples of the commercially available product of the trishydroxyphenylmethane epoxy compound include trade name “EPPN-503, EPPN-502H, EPPN-501H” (manufactured by Nippon Kayaku Co., Ltd.), trade name “TACTIX-742” (manufactured by The Dow Chemical Company), “JER1032H60” (manufactured by Mitsubishi Chemical Corporation), and the like. Furthermore, examples of the commercially available product of the tetrakis hydroxyphenylethane epoxy compound include trade name “jER 1031S” (manufactured by Mitsubishi Chemical Corporation), or the like. Examples of the glycidyl amine epoxy compound include trade name “YH-434, YH-434L” (manufactured by Nippon Steel & Sumikin Chemical Co., Ltd.) as a tetravalent glycidyl amine epoxy compound, trade name “jER604” (manufactured by Mitsubishi Chemical Corporation), and the like. Examples of the compound containing a polyvalent glycidyl group where a trivalent or higher compound having a phenol structure or aminophenyl structure in the same molecule is glycidylated include trade name “jER630” (manufactured by Mitsubishi Chemical Corporation) as a trivalent glycidyl amine epoxy compound, or the like.

In the case where the epoxy compound (B) containing a trivalent or higher polyvalent glycidyl group is used in a combination, the content ratio of the epoxy compound (B) containing a trivalent or higher polyvalent glycidyl group is not particularly limited, but is preferably 0.1 to 40 wt. %, more preferably 1 to 30 wt. %, and particularly preferably 3 to 25 wt. % with regard to a total of 100 wt. % of the epoxy compound that is used. By setting the amount of the epoxy compound (B) containing a trivalent or higher polyvalent glycidyl group in the thermosetting resin composition to the aforementioned range in relation to the aforementioned polyvalent epoxy compound (A), the obtained cured resin layer can have further increased heat resistance, electrical properties, and adhesion to the conductor layer.

Furthermore, in addition to the polyvalent epoxy compound (A) and epoxy compound (B) containing a trivalent or higher polyvalent glycidyl group, the thermosetting resin composition used in the present invention can appropriately contain additional epoxy compounds other than the aforementioned epoxy compounds. Examples of additional epoxy compounds include epoxy compounds containing phosphorus. An example of epoxy compounds containing phosphorus preferably includes epoxy compounds having a phosphaphenanthrene structure, and by further using the epoxy compound having a phosphaphenanthrene structure, the obtained cured resin layer can have further improved heat resistance, electrical properties, and adhesion to the conductor layer.

Note that as other epoxy compounds, other than or in addition to the epoxy compounds having a phosphaphenanthrene structure, alicyclic epoxy compounds, cresol novolak epoxy compounds, phenol novolak epoxy compounds, bisphenol A novolak epoxy compounds, trisphenol epoxy compounds, tetrakis (hydroxyphenyl) ethane epoxy compounds, aliphatic chain epoxy compounds, and the like can be used, and can be procured appropriately as commercially available products.

Furthermore, the thermosetting resin composition used in the present invention may contain a phenol resin (C) containing a triazine structure. The phenol resin (C) containing a triazine structure is a condensation polymer of aromatic hydroxy compounds such as phenol, cresol, and naphthol, compounds having a triazine ring such as melamine and benzenguanamine, and formaldehyde. The phenol resin (C) containing a triazine structure typically has a structure as expressed by the following general Formula (1).

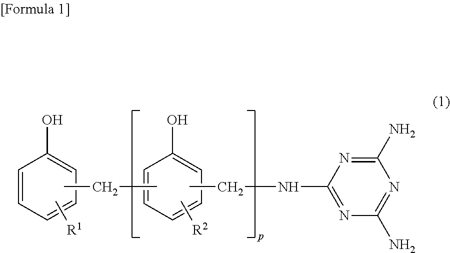

(In Formula (1), R¹, R² are a hydrogen atom or a methyl group, and p is an integer of 1 to 30. Furthermore, R¹, R² may be the same or different from each other, and furthermore, when p is 2 or greater, a plurality of R² may be the same or different from each other. Furthermore, in Formula (1), in at least one of the amino groups, a hydrogen atom contained in the amino group can be substituted with another group (an alkyl group or the like, for example).)

The phenol resin (C) containing a triazine structure acts as a curing agent of the epoxy compound by the presence of a phenolic active hydroxy group, and particularly, the obtained cured resin layer exhibits excellent adhesion to the substrate by containing the phenol resin (C) containing a triazine structure.

The phenol resin (C) containing a triazine structure can be manufactured according to a known method, and can also be obtained as a commercially available product. Examples of the commercially available product include trade name “LA7052, LA7054, LA3018, LA1356” (manufactured by DIC Corporation) or the like. The phenol resin (C) containing a triazine structure can be used independently or in a combination of two or more types.

The added amount of the phenol resin (C) containing a triazine structure in the thermosetting resin composition used in the present invention is preferably in a range of 1 to 60 parts by weight, more preferably 2 to 50 parts by weight, even more preferably 3 to 40 parts by weight, and particularly preferably 4 to 20 parts by weight with regard to a total of 100 parts by weight of the epoxy compound that is used.

Furthermore, the equivalent ratio of the epoxy compound that is used and the phenol resin (C) containing a triazine structure in the thermosetting resin composition used in the present invention (ratio of the total number of active hydroxyl group content in the phenol resin (C) containing a triazine structure, with regard to the total number of epoxy groups of the epoxy compound that is used (active hydroxyl group content/epoxy group content)) is preferably within a range of 0.01 to 0.6, more preferably 0.05 to 0.4, and even more preferably 0.1 to 0.3. By setting the added amount of the phenol resin (C) containing a triazine structure to the aforementioned range, electrical properties and heat resistance of the obtained cured resin layer can be improved. Note that the equivalent ratio of the epoxy compound that is used and the phenol resin (C) containing a triazine structure can be determined from the total epoxy equivalent of the epoxy compound that is used, and the total active hydroxyl group equivalent of the phenol resin (C) containing a triazine structure.

Furthermore, the thermosetting resin composition used in the present invention preferably contains an active ester compound (D) in addition to the aforementioned components. The active ester compound (D) preferably has an active ester group, but in the present invention, the active ester compound (D) is preferably a compound having at least two active ester groups in a molecule. The active ester compound (D) acts as a curing agent of the epoxy compound used in the present invention, similarly to the phenol resin (C) containing a triazine structure, by an epoxy site and an epoxy group reacting by heating.

From the perspective of increasing the heat resistance of the obtained cured resin layer, the active ester compound (D) is preferably an active ester compound obtained by reacting a carboxylic acid compound and/or thiocarboxylic acid compound with a hydroxy compound and/or thiol compound, more preferably an active ester compound obtained by reacting one or two types or more selected from a group of carboxylic acid compounds, phenol compounds, naphthol compounds, and thiol compounds, and particularly preferably an aromatic compound obtained by reacting a carboxylic acid compound with an aromatic compound having a phenolic hydroxyl group, and having at least two active ester groups in a molecule. The active ester compound (D) may have a straight chain or multi-branched shape, and in the case where the active ester compound (D) is derived from a compound having at least two carboxylic acids in a molecule, as an example, if the compound having at least two carboxylic acids in a molecule contains an aliphatic chain, compatibility with an epoxy compound can be increased, and if the compound contains an aromatic ring, the heat resistance will be increased.

Specific examples of the carboxylic acid compound for forming the active ester compound (D) include benzoic acids, acetic acids, succinic acids, maleic acids, itaconic acids, phthalic acids, isophthalic acids, terephthalic acids, pyromellitic acids, and the like. Of these, from the perspective of increasing the heat resistance of the obtained cured resin layer, the carboxylic acid compound is preferably a succinic acid, maleic acid, itaconic acid, phthalic acid, isophthalic acid, or terephthalic acid, more preferably a phthalic acid, isophthalic acid, and diphthalic acid, and even more preferably an isophthalic acid, and terephthalic acid.

Specific examples of the thiocarboxylic acid compound for forming the active ester compound (D) include thioacetic acids, thiobenzoic acids, and the like.

Specific examples of the hydroxy compound for forming the active ester compound (D) include hydroquinone, resorcin, bisphenol A, bisphenol F, bisphenol S, phenophtharin, methylated bisphenol A, methylated bisphenol F, methylated bisphenol S, phenol, o-cresol, m-cresol, p-cresol, catechol, α-naphthol, β-naphthol, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, phloroglucin, benzene triol, dicyclopentadienyl diphenol, phenol novolak, and the like. Of these, from the perspective of improving solubility of the active ester compound (D) as well as increasing the heat resistance of the obtained cured resin layer, the hydroxy compound is preferably 1,5-dihydroxynaphthalene, 1,6-dihydroxynaphthalene, 2,6-dihydroxynaphthalene, dihydroxyhenzophenone, trihydroxybenzophenone, tetrahydroxybenzophenone, dicyclopentadienyl diphenol, and phenol novolac, more preferably dihydroxyhenxophenone, trihydroxyhenzophenone, tetrahydro, roxybensophenone, dicyclopentadienyl diphenol, and phenol novolak, and even more preferably dicyclopentadienyl diphenol, and phenol novolak.

Specific examples of the thiol compound for forming the active ester compound (D) include benzenedithiol, triazindithiol, and the like.

The manufacturing method of the active ester compound (D) Is not particularly limited, and the compound can be manufactured by a known method. For example, the compound can he obtained by condensation reaction of the aforementioned carboxylic acid compound and/or thiocarboxylic acid compound with a hydroxy compound and/or thiol compound.

For example, an aromatic compound having an active ester group disclosed in JP-A-2002-12650, a polyfunctional polyester disclosed in JP-A-2004-277460, and commercially available products cars be used as the active ester compound (D). Examples of the commercially available products include trade name “EXB 9451, EXB 9460, EXB 9460S, Epiclon HPC-8000-6ST” (“Epiclon” is a registered trademark, manufactured by DIC Corporation), trade name “DC 808” (manufactured by Japan Epoxy Resins Co., Ltd.), trade name “YLH1026” (Japan Epoxy Resins Co., Ltd,), and the like.

The added amount of the active ester compound (D) in the thermosetting resin composition used in the present invention is preferably in a range of 10 to 150 parts by weight, more preferably 15 to 130 parts by weight, and even more preferably 20 to 120 parts by weight with regard to a total of 100 parts by weight of the epoxy compound that is used.

Furthermore, the equivalent ratio of the epoxy compound that is used and the active ester compound (D) in the thermosetting resin composition used in the present invention (ratio of the total number of reactive groups of the active ester compounds (D), with regard to the total number of epoxy groups of the epoxy compound that is used (active ester group content/epoxy group content)) is preferably within a range of 0.5 to 1.1, more preferably 0.6 to 0.9, and even more preferably 0.65 to 0.85.

Furthermore, the equivalent ratio of the epoxy compound that is used, the phenol resin (C) containing a triazine structure, and the active ester compound (D) in the thermosetting resin composition used in the present invention (ratio of the total number of epoxy groups in the epoxy compound that is used, with regard to the active hydroxyl group of the phenol resin (C) containing a triazine structure and the active ester group of the active ester compound (D) (epoxy group content/(active hydroxyl group content+active ester group content)) is usually within a range of less than 1.1, preferably 0.6 to 0.99, and more preferably 0.65 to 0.95. By setting the equivalent ratio to the aforementioned range, the obtained cured resin layer can exhibit good electric properties. Note that the equivalent ratio of the epoxy compound that is used, and the phenol resin (C) containing a triazine structure and the active ester compound (D) can be determined from the total epoxy equivalent of the epoxy compound that is used, and the total active hydroxyl group equivalent of the phenol resin (C) containing a triazine structure and the total active ester equivalent of the active ester compound (D).

After forming the undried resin film from the thermosetting resin composition, the boiling point of the solvent is preferably 30 to 250° C., and more preferably 50 to 200° C. from the perspective of volatilizing and removing the solvent by drying in the second step. Specific examples of the solvent include: toluene, xylene, ethyl benzene, trimethyl benzene, anisole, and other aromatic hydrocarbons; n-pentane, n-hexane, n-heptane, methyl ethyl ketone, methyl isobutyl ketone, and other aliphatic hydrocarbons; cyclopentane, cyclohexane, cyclopentanone, cyclohexanone, and other cyclic hydrocarbons; chlorobenzene, dichlorobenzene, trichlorobenzene, and other halogenated hydrocarbons; and the like. Of these, toluene, anisole, cyclohexanone, cyclopentanone, and the like are preferably used from the perspective of compatibility with components configuring the thermosetting resin composition.

The amount of the solvent in the thermosetting resin composition is preferably 5 to 40 wt. %, more preferably 10 to 35 wt. %, arid even more preferably 15 to 30 wt. %. When the solvent amount is too low, forming the undried resin film may be difficult, but on the other hand, when the solvent amount is too high, the moldability of the undried resin film may deteriorate, and thus forming a uniform film may be difficult.

Furthermore, an inorganic filler is preferably included in the thermosetting resin composition used in the present invention. By including the inorganic filler, the obtained cured resin film can have a low linear expansion. Specific examples of the inorganic filler include calcium carbonate, magnesium carbonate, barium carbonate, zinc oxide, titanium oxide, titania oxide, magnesium silicate, calcium silicate, zirconium silicate, hydrated aluminas, magnesium hydroxide, aluminum hydroxide, barium sulfate, silica, talc, clay, and the like. Note that the inorganic filler that is used can be previously surface treated with a silane coupling agent or the like. The amount of the inorganic filler in the thermosetting resin composition used in the present invention is not particularly limited, but is preferably 60 wt. % or greater, more preferably 62 to 90 wt. % or greater, and even more preferably 65 to 80 wt. % or greater, calculated as solid content. When the amount of the inorganic filler is too low, the coefficient of linear expansion of the obtained cured resin film may increase, and the connection reliability may be inferior.

Furthermore, in addition to the aforementioned components, the thermosetting resin composition used in the present invention can further contain other components as described below.

The thermosetting resin composition may optionally contain a curing promoting agent. The curing promoting agent is not particularly limited, but examples thereof include aliphatic polyamines, aromatic polyamines, secondary amines, tertiary amines, acid anhydrides, imidazole derivatives, organic acid hydrazides, dicyandiamides, derivatives thereof, urea derivatives, and the like. Of these, imidazole derivatives are particularly preferable.

The imidazole derivative is not particularly limited as long as it is a compound having an imidazole skeleton, and examples include 2-ethylimidazole, 2-ethyl-4-methylimidazole, bis-2-ethyl-4-methylimidazole, 1-methyl-2-ethylimidazole, 2-isopropylimidazole, 2,4-dimethylimidazole, 2-heptadecylimidazole, and other alkyl-substituted imidazole compounds; 2-phenylimidazole, 2-phenyl-4-methylimidazole, 1-benzyl-2-methylimidazole, 1-benzyl-2-ethylimidazole, 1-benzyl-2-phenylimidazole, benzimidazole, 2-ethyl-4-methyl-1-(2′-cyanoethyl) imidazole, and other imidazole compounds substituted with a hydrocarbon group containing a cyclic structure such as an aryl group and an aralkyl group. These may be used independently as one type or may be used in a combination of two or more types.

The added amount of the curing promoting agent in the thermosetting resin composition used in the present invention is usually 0.1 to 10 parts by weight and preferably 0.5 to 8 parts by weight with regard to a total of 100 parts by weight of the epoxy compound that is used.

Furthermore, for the purpose of improving flame retardancy of the obtained cured resin layer, a flame retardant that is added to a general resin composition for forming an electrical insulating film such as halogen type flame retardants or phosphate ester type flame retardants, for example, may be appropriately added to the thermosetting resin composition.

Furthermore, if desired, flame retardant auxiliary agents, heat resistant stabilizers, weather resistant stabilizers, antioxidants, ultraviolet absorbers (laser processability improver), leveling agents, antistatic agents, slip agents, anti-blocking agents, anti-fogging agents, lubricants, dyes, natural oils, synthetic oils, waxes, emulsions, magnetic materials, dielectric property adjusting agents, toughening agents, and other known components may be appropriately added to the thermosetting resin composition of the present invention.

The method of preparing the thermosetting resin composition used in the present invention is not particularly limited, and the aforementioned components may be mixed as they are, may be mixed as a state dissolved or dispersed in an organic solvent, or a composition In a state wherein a portion of the components are dissolved or dispersed in an organic solvent may be prepared, and then the remaining components may be mixed into the composition.

In the first step of the manufacturing method of the present invention, the thermosetting resin composition described above can be used to form onto the supporting body the undried resin film formed from the thermosetting resin composition to obtain, the undried resin film formed on the supporting body.

The method for forming onto the supporting body the undried resin film made from the thermosetting resin composition is not particularly limited, but a method of coating, spraying, or casting the thermosetting resin composition onto the supporting body and then drying is preferable.

The thickness of the undried resin film is not particularly limited, but is usually 10 to 100 μm, preferably 12 to 90 μm, and more preferably 15 to 80 μm from the perspective of workability and the like.

Examples of the method of coating the thermosetting resin composition include dip coating, roller coating, curtain coating, die coating, slit coating, gravure coating, and the like.

### Second Step

The second step of the manufacturing method of the present invention is configured to dry the undried resin film formed on the supporting body by transporting in a floating system in a drying device in a condition formed on the supporting body to obtain a curable resin film with a heating loss amount of 0.5 to 7 wt. %.

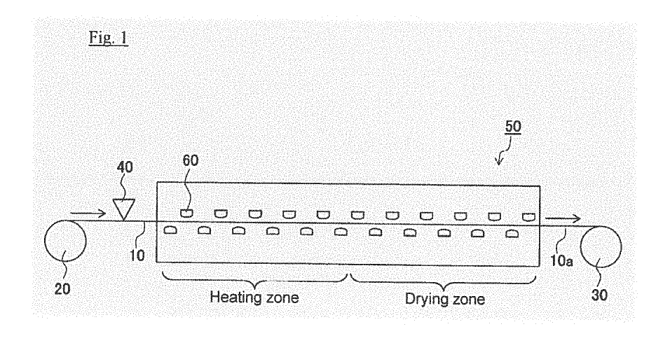

In the manufacturing method of the present invention, the method of drying the undried resin film formed on the supporting body by transporting by a floating system in a drying device is not particularly limited, and may be a method of drying in a form where the undried resin film formed on the supporting body is transported inside a drying device in a condition supported by hot air for drying (floating condition). For example, a manufacturing device illustrating in FIG. 1 can be used. Herein, FIG. 1 is a diagram illustrating an example of a manufacturing device used in the manufacturing method of the present invention. A case of using the manufacturing device illustrated in FIG. 1 is exemplified below to describe the second step of the manufacturing method of the present invention.

The manufacturing device illustrated in FIG. 1 is a device form performing the aforementioned first step and second step. In the manufacturing device illustrated in FIG. 1, a supporting body is continuously unrolled from a first roller 20 around which an elongated supporting body is wound, a thermosetting resin composition is coated on the supporting body by a coating device 40, and thereby, an undried resin film 10 with a supporting body is continuously formed. Furthermore, the undried resin film 10 with a supporting body is continuously transported into a drying device 50 and dried by the drying device 50, and then after a solvent is removed to obtain a curable resin film 10a with a supporting body, the film is continuously wound on a second roller 30. Furthermore, at this time, when the undried resin film 10 with a supporting body is continuously transported in the drying device 50, the film is transported in a condition (floating condition) supported by hot air for drying blown out from a plurality of hot air outlets 60 provided in the drying device 50.

Furthermore, at this time, the heating loss amount of the curable resin film obtained by drying is controlled to a range of 0.5 to 7 wt. % in the present invention.

Furthermore, according to the present invention, by using the floating system, the film pressure of the undried resin film 10 with a supporting body can be uniformly maintained in the drying device 50, and thus the thickness of the curable resin film 10a with a supporting body alter drying and the thickness of cured resin film obtained by curing the curable resin film can be uniform, and heat shrinkage during curing can be suppressed by setting the heating loss amount of the curable resin film within a range of 0.5 to 7 wt. %. As a result, a cured resin film where defects such as wrinkles or bubbles are effectively prevented from occurring can be obtained with high productivity.

In the present invention, the heating loss amount of the curable resin film obtained by drying is within a range of 0.5 to 7 wt. %, but if the heating loss is too low, when the curable resin film is laminated on a substrate having a wiring pattern, a void or the like may occur between wiring, and embedding properties failure (phenomenon where the space between the wiring cannot be completely embedded, and air is incorporated) may occur. On the other hand, when the heating loss amount is too high, a problem occurs where the cured resin film forms bubbles due to the influence of residual solvent when cured in a condition with a release PET film attached. In the present invention, the heating loss amount of the curable resin film obtained by drying is within a range of 0.5 to 7 wt. %, preferably within a range of 1 to 6 wt. %, more preferably within a range of 1.3 to 5 wt. %, and even more preferably within a range of 1.5 to 4 wt. %. Note that the heating loss amount of the curable resin film can be determined by measuring the weight loss amount due to heat when heating the curable resin film for 15 minutes at 170° C. in a nitrogen atmosphere, using a differential thermogravimetric simultaneous measuring device (TG-DTA).

Note that the method of setting the heating loss amount of the curable resin film within the aforementioned specific range is not particularly limited, and examples include methods of appropriately controlling the drying temperature when drying inside the drying device 50, drying temperature distribution (temperature gradient or the like) in the drying device 50, drying time (residence time in the drying device 50), and drying air flowrate during drying (air flowrate of hot air for drying discharged from the hot air outlet 60), based on the type of the used curable resin film and solvent, added amount of the solvent, thickness of the undried resin film, and the like. Furthermore, in the manufacturing method of the present invention, by setting the conditions within a specific range for a specific combination, the heating loss amount of the curable resin film can be set within the aforementioned specific range, and thereby, a cured resin film where defects such as wrinkles or bubbles are prevented from occurring can be obtained with high productivity. In the manufacturing method of the present invention, examples of conditions for setting the heating loss amount of the curable resin film within the aforementioned specific range can include the following conditions, and the conditions are preferably appropriately controlled based on the type of the used curable resin film and solvent, added amount of the solvent, thickness of the undried resin film, and the like.

In other words, in the manufacturing method of the present invention, the inside of the drying device 50 has two zones, namely, a heating zone and drying zone, and the temperature range thereof is preferably within the following range. The temperature of the heating zone at this time is preferably 30 to 60° C. more preferably 40 to 60° C., and even more preferably 45 to 55° C. When the temperature of the heating zone is too high, problems may occur where bubbles occur in the undried resin film or the flatness deteriorates, but when the temperature of the heating zone is too low, problems may occur where the time required for drying increases, thereby reducing production efficiency, and drying is insufficient.

Furthermore, the temperature of the drying zone is preferably higher than the temperature of the heating zone, and more preferably 60 to 100° C., even more preferably 60 to 95° C., and particularly preferably 60 to 90° C. When the temperature of the drying zone is too high, problems occur where bubbles occur in the undried resin film, or the flatness deteriorates, or problems occur where drying advances too far and thus the curable resin film obtained by the drying is mechanically brittle, or a curing reaction advances and thus the film has inferior wiring embedding properties. On the other hand, when the temperature of the drying zone is too low, problems may occur where the time required for drying increases and thus the production efficiency is reduced, and drying is insufficient.

Note that the present invention has a form where the temperature of the heating zone may be a uniform temperature for the entire heating zone, but the heating zone is preferably further divided into a plurality of zones, and the temperature thereof preferably gradually increases based on the advancement of the undried resin film 10 with a supporting body. Similarly, the temperature of the drying zone may be a uniform temperature for the entire drying zone, but the drying zone is preferably further divided into a plurality of zones, and the temperature thereof is preferably in a form where the temperature gradually increases based on the advancement of the undried resin film 10 with a supporting body. In this case, the maximum temperature of the heating zone and drying zone is preferably within the aforementioned temperature range, and for example, the temperature may be essentially the same at a boundary portion between the heating zone and drying zone.

Furthermore, the drying time (residence time in the drying device 50) of the undried resin film in the present invention is preferably 30 to 300 second, more preferably 60 to 180 seconds, and even more preferably 90 to 150 seconds. When the drying time is too long, the amount of heat applied on the supporting body is high, and as a result, heat shrinkage is high when curing the curable resin film 10a with a supporting body after drying, and thus defects such as wrinkles are prone to occur. On the other hand, when the drying time is too short, a problem may occur where drying is insufficient.

Furthermore, the drying air flowrate (air flowrate of hot air for drying discharged from the hot air outlet 60) during drying of the undried resin film in the present invention is preferably 0.5 to 7 m³/hour, more preferably 1 to 6 m³/hour, and even more preferably 2.5 to 4.5 m³/hour. When the drying air flowrate is too high, the undried resin film 10 with a supporting film flaps during drying, a phenomenon where deviation in a width direction during transporting occurs, the uniformity of the thickness of the undried resin film 10 with a supporting body deteriorates, and the reliability of the obtained cured resin film deteriorates. On the other hand, when the drying air flowrate is too low, support of the undried resin film 10 with a supporting body by the hot air for drying may be insufficient, deflection may occur on the undried resin film 10 with a supporting body, and transporting of the undried resin film 10 with a supporting body may be difficult.

The thickness of the curable resin film is not particularly limited, but is usually 1 to 100 μm, preferably 5 to 80 μm, and more preferably 10 to 60 μm from the perspective of workability and the like.

Furthermore, in the present invention, the curable resin film is preferably in an uncured or semi-cured condition. Herein, “uncured” refers to a state where the entire curable resin substantially dissolves when the curable resin film is immersed into a solvent that can dissolve the curable resin (epoxy resin, for example) that is used for preparing the thermosetting resin composition. Furthermore, semi-cured refers to a state where the composition is partially cured where further curing can be performed if further heating is performed, and preferably a state where a portion (specifically an amount of 7 wt. % or greater with a portion remaining) of the curable resin dissolves in a solvent that can dissolve the curable resin used for preparing the thermosetting resin composition, or a state where the volume after immersing the compact into the solvent for 24 hours is 200% or greater than the volume before immersing (swelling ratio).

With the second step of the manufacturing method of the present invention, drying is performed on the undried resin film formed on the supporting body as described above to obtain a curable resin film (cured resin film 10a with a supporting body) with a heating loss amount of 0.5 to 7 wt. %, formed on the supporting body. Note that if the manufacturing device illustrated in FIG. 1 is used, the curable resin film with a 0.5 to 7 wt. % heating loss amount, formed on the supporting body, is obtained in a condition wrapped around the second roller 30.

### Second Curable Resin Film Forming Step

Furthermore, the manufacturing method of the present invention may be configured such that prior to the aforementioned first step, a second curable resin, film containing a second curable resin that is different from the aforementioned curable resin is formed in advance, and then the first step and second step are performed to form the aforementioned curable resin film on the second curable resin film. In other words, the film may be a multilayer curable resin film provided with the second curable resin film and the curable resin film formed by the aforementioned first step and second step on the supporting body in this order. Note that In this case, a second curable resin film can be used as a layer to be plated for forming the conductor layer by electroless plating or the like, and the curable resin film formed the first step and second step can be used as an adhesive layer for adhering to the substrate for example.

Furthermore, hereinafter the second curable resin film is referred to as “second curable resin film”, the second curable resin configuring the second curable resin film is referred to as “second curable resin”, thermosetting resin composition for forming the second curable resin is referred to as “second thermosetting resin composition”, and the second undried resin film containing the second thermosetting resin composition is referred to as “second undried resin film”. Furthermore, the curable resin film and the like according to the first step and second step are similarly respectively referred to as “first curable resin film”, “first curable resin”, “first thermosetting resin composition”, and “first undried resin film”.

A forming method of a second curable resin film in the second curable resin film forming step is described. Other than using the second thermosetting resin composition containing a solvent and the second curable resin film that is different from the first curable resin film in addition to the first thermosetting resin composition containing the first curable resin and the solvent, the second curable resin film can be formed similarly to the first curable resin film. In other words, in the second curable resin film forming step, the second undried resin film containing the second thermosetting resin composition containing the second curable resin and solvent is formed on the supporting body, and then the second undried resin film formed on the supporting body is dried by transporting by a floating system in the drying device in a condition formed on the supporting body to obtain the second curable resin film. Note that at this time, the total heating loss amount between the first curable resin film and second curable resin film is preferably within a range of 0.5 to 7 wt. %, more preferably with a range of 1 to 6 wt. %, and even more preferably within a range of 13 to 5 wt. %.

The second thermosetting resin composition used In the present invention contains the second curable resin and solvent, and usually contains a curing agent in addition thereto. The second curable resin is not particularly limited, but preferably contains an alicyclic olefin polymer having a polar group from the perspective of improving heat resistance and electrical properties of the obtained cured resin film.

The alicyclic olefin polymer having a polar group is not particularly limited, and examples of the alicyclic structure include cycloalkane structures, cycloalkene structures, and the like. From the perspective of having excellent mechanical strength and heat resistance, having a cycloalkane structure is preferable. Furthermore, examples of the polar group contained in the alicyclic olefin polymer include alcoholic hydroxyl groups, phenolic hydroxyl groups, carboxyl groups, alkoxyl groups, epoxy groups, glycidyl groups, oxycarbonyl groups, carbonyl groups, amino groups, carboxylic acid anhydride groups, sulfonic acid groups, phosphoric acid groups, and the like. Of these, carboxyl groups, carboxylic acid anhydride groups, and phenolic hydroxyl groups are preferable, and carboxylic acid anhydride groups are more preferable.

Furthermore, the curing agent contained in the second thermosetting resin composition is not particularly limited as long as the curing agent can form a crosslinked structure to the alicyclic olefin polymer having a polar group by heating, and a curing agent that is added to the general resin composition for forming an electrical insulating film can be used. The curing agent is preferably a compound having two or more functional groups that can form a bond by reacting with the polar group of the alicyclic olefin polymer having a polar group that is used.

For example, examples of the curing agent that is preferably used in cases using an alicyclic olefin polymer having a carboxyl group, carboxylic acid anhydride group, or phenolic hydroxyl group as die alicyclic olefin polymer having a polar group, include polyvalent epoxy compounds, polyvalent isocyanate compounds, polyvalent amine compounds, polyvalent hydrazide compounds, aziridine compounds, basic metal oxides, organometallic halides, and the like. One type thereof may be used independently, or two or more types thereof may be used in combination. Furthermore, the compounds can be used in combination with peroxides to use as a curing agent.

Of these, from the perspective of having gentle reactivity between the alicyclic olefin polymer having a polar group and the polar group thereof, the curing agent is preferably a polyvalent epoxy compound, and particularly preferably a glycidyl ether type epoxy compound or alicyclic polyvalent epoxy compound.

The added amount of the curing agent in the second thermosetting resin composition is preferably within a range of 1 to 100 parts by weight, more preferably 5 to 80 parts by weight, and even more preferably 10 to 50 parts by weight with regard to 100 parts by weight of the alicyclic olefin polymer having a polar group. By setting the added amount of the curing agent to the aforementioned range, mechanical strength and electrical properties of the cured resin layer can be favorable.

Furthermore, the second thermosetting resin composition may contain hindered phenol compounds or hindered amine compounds in addition to the aforementioned components.

The hindered amine compound is a phenol compound having at least one hindered structure that has a hydroxyl group and that does not have a hydrogen atom on a carbon atom at a β site of the hydroxyl group. Specific examples of the hindered phenol compound include 1,1,3-tris-(2-methyl-4-hydroxy-5-tert-butylphenyl) butane, 4,4′-butylidene bis-(3-methyl-6-tert-butyl phenyl), 2,2-thio bis (4,4′-methyl-6-tert-butyl phenyl), n-octadecyl-3-(4′-hydroxy-3′,5′,-di-tert-butyl phenyl) propionate, tetrakis-[methylene-3-(3′,5′-di-tert-butyl-4′-hydroxy phenyl) propionate] methane, and the like.

The added amount of the hindered phenol compound in the second thermosetting resin composition is not particularly limited, but preferably within a range of 0.04 to 10 parts by weight, more preferably 0.3 to 5 parts by weight, and even more preferably 0.5 to 3 parts by weight with regard to 100 parts by weight of the alicyclic olefin polymer having a polar group. By setting the added amount of the hindered phenol compound to the aforementioned range, mechanical strength and electrical properties of the obtained cured resin film can be favorable.

Furthermore, the hindered amine compound is a compound having in a molecule at least one 2,2,6,6-tetraalkylpiperidine group having a secondary amine or tertiary amine at position 4. The number of carbon atoms of alkyl is usually 1 to 50. The hindered amine compound is preferably a compound having in a molecule at least one 2,2,6,6-tetramethylpiperidyl group having a secondary amine or tertiary amine at position 4. Note that in the present invention, the hindered phenol compound and hindered amine compound is preferably used in combination, and by using in combination, in the case of performing surface roughening treatment by using an aqueous solution of permanganate or the like for the cured resin film, even in the case where the surface roughening treatment condition is changed, a cured product with low surface roughness can be maintained after surface roughening treatment.

Specific examples of the hindered amine compound include bis (2,2,6,6-tetramethyl-4-piperidyl) sebacate, bis (1,2,2,2,6,6-pentamethyl-4-piperidyl) sebacate, 1 [2-{3-(3,5-di-tert-butyl-4-hydroxyl phenyl) propionyloxy} ethyl]-4-{3-(3,5-di-tert-butyl-4-hydroxy phenyl) propionyloxy}-2,2,6,6-tetramethyl piperidine, 8-benzyl-7,7,9,9-tetramethyl-3-octyl-1,2,3-triazaspiro [4,5] undecane-2,4-dione, and the like.

The added amount of the hindered amine compound is not particularly limited, but is usually 0.02 to 10 parts by weight, preferably 0.2 to 5 parts by weight, and more preferably 0.25 to 3 parts by weight with regard to 100 parts by weight of the alicyclic olefin polymer having a polar group. By setting the added amount of the hindered amine compound to the aforementioned range, mechanical strength and electrical properties of the obtained cured resin film cars be favorable.

Furthermore, the second thermosetting resin composition may contain a curing promoting agent in addition to the aforementioned components. A curing promoting agent added to the general resin composition for forming an electrical insulating film is preferably used as the curing promoting agent, and a curing promoting agent similar to the aforementioned first thermosetting resin composition can be used, for example. The added amount of the curing promoting agent in the second thermosetting resin composition may be appropriately selected according to the purpose of use, but is preferably 0.001 to 30 parts by weight, more preferably 0.01 to 10 parts by weight, and even more preferably 0.03 to 5 parts by weight with regard to 100 parts by weight of the alicyclic olefin polymer having a polar group.

Furthermore, the second thermosetting resin composition may contain an inorganic filler in addition to the aforementioned components. A similar filler as the inorganic filler used in the first thermosetting resin composition can be used as the filler. The added amount of the inorganic filler in the second thermosetting resin composition is preferably 10 wt. % or greater, more preferably 15 to 60 wt. %. and even more preferably 20 to 40 wt. %, as calculated as solid content.

Furthermore, in addition to the aforementioned components, curing promoting agents, flame retardants, flame retardant auxiliary agents, heat resistant stabilizers, weather resistant stabilizers, antioxidants, ultraviolet absorbers (laser processability improver), leveling agents, antistatic agents, slip agents, anti-blocking agents, anti-fogging agents, lubricants, dyes, natural oils, synthetic oils, waxes, emulsions, magnetic materials, dielectric property adjusting agents, toughening agents, and other known components may he appropriately added to the second thermosetting resin composition, similarly to the first thermosetting resin composition.

The manufacturing method of the second thermosetting resin composition is not particularly limited, and the aforementioned components may be mixed as they are, or may be mixed in a state dissolved or dispersed in an organic solvent, or a composition in a state wherein a portion of the components are dissolved or dispersed in an organic solvent may be prepared, and then the remaining components may be mixed into the composition.

In second curable resin film forming step, the second undried resin film can be formed on the supporting body using the same supporting body, and drying can be performed by the floating system to obtain the second curable resin film with a supporting body formed from the second curable resin film being formed on the supporting body for example, similar to the first step and second step. Furthermore, by passing through the first step and second step using the second curable resin film with a supporting body obtained thereby, a multilayer curable resin film where the first curable resin film and second curable resin film are formed on the supporting body can be obtained.

Note that the drying conditions (in other words, the temperature conditions, drying time, and drying air flowrate of the heating zone and drying zone) when drying the second undried resin film by the floating system may be the same as the aforementioned second step.

Furthermore, the thickness of the second undried resin film at this time is not particularly limited, but is usually 5.0 to 40 μm, preferably 8.0 to 30 μm, and more preferably 12 to 25 μm, and the thickness of the second curable resin film after drying is usually 1.0 to 6.0 μm, preferably 1.5 to 5.5 μm, and more preferably 2.5 to 4.5 μm.

Furthermore, in the present invention, the second curable resin, film is also preferably in an uncured or semi-cured condition, similar to the first curable resin film. Herein, “uncured” refers to a state where the entire second curable resin substantially dissolves when the second curable resin film is immersed into a solvent that can dissolve the second curable resin (epoxy resin, for example) that is used for preparing the second thermosetting resin composition. Furthermore, semi-cured refers to a state where the composition is partially cured where further curing can be performed if further heating is performed, and preferably a state where a portion (specifically an amount of 7 wt. % or higher with a portion remaining) of the second curable resin dissolves in a solvent that can dissolve the second curable resin used for preparing the second thermosetting resin composition, or a state where the volume alter immersing the compact into the solvent for 24 hours is 200% or greater than the volume before immersing (swelling ratio).

Note that in the manufacturing method of the present invention, in order to achieve a condition where the second curable resin film is uncured or semi-cured, the first undried resin film is formed on the second curable resin film, and the drying conditions when drying the film are preferably conditions considering the second curable resin configuring the second curable resin film, in other words, conditions where a curing reaction of the second curable resin does not advance.

### Third Step

The third step of the manufacturing method of the present invention is a step of thermal curing the curable resin film or multilayer curable resin film formed on the supporting body to obtain a cured resin film.

The heating temperature in the third step may be appropriately set according to the curing temperature of the curable resin film or the type of the supporting body, but is preferably 100 to 250° C. preferably 120 to 220° C., and more preferably 150 to 210° C. Furthermore, the heating time in the third step is usually 0.1 to 3 hours and preferably 0.25 to 1.5 hours. The method of heating is not particularly limited, and may be performed by using an electric oven or the like, for example. Furthermore, the thermal curing is preferably performed in an atmosphere from the perspective of productivity.

Furthermore, in the third step of the manufacturing method of the present invention, prior to thermal curing the curable resin film, the curable resin film formed on the supporting body is laminated on a substrate at a curable resin film forming surface (first curable resin film forming surface if using the multilayer curable resin film containing the first curable resin film and second curable resin film), and thereby, a composite is achieved where the curable resin film and substrate are formed in this order on the supporting body, and by thermal curing in this laminate body condition, a cured composite where the cured resin film and substrate are formed in this order on the supporting body is preferably obtained. Note that in this case, in the fourth step described later, the supporting body can be peeled from the cured composite to obtain a laminate body containing the cured resin film and substrate of the present invention.

The substrate is not particularly limited, and examples include: substrates having a conductor layer on a surface thereof, or the like. The substrate having a conductor layer on the surface thereof has a conductor layer on a surface of an electrical insulating substrate, and examples of the electrical insulating substrate include products that were formed by curing a resin composition containing a known electrical insulating material (alicyclic olefin polymers, epoxy compounds, maleimide resin, (meth) acrylic resin, diallyl phthalate resin, triazine resin, polyphenylene ether, glass, and the like, for example). Furthermore, the conductor layer is not particularly limited, but is usually a layer containing a wiring formed by a conductive body such as conductive metal, and may further contain various circuits. Configuration, thickness, and the like of the wiring and circuit are not particularly limited. Specific examples of the substrate having a conductor layer on a surface thereof include printed-wiring assemblies, silicon wafer substrates, and the like. The thickness of the substrate having a conductor layer on a surface thereof is usually 10 μm to 10 mm, preferably 20 μm to 5 mm, and more preferably 30 μm to 2 mm. Note that the height (thickness) of the wiring in the substrate having a conductor layer on a surface thereof is usually 3 to 35 μm. Furthermore, from the perspective of improving wiring embedding properties and insulation reliability when formed into a cured resin layer, the difference “thickness of the curable resin film—height (thickness) of the wiring” between the thickness of the curable resin film and the height (thickness) of the wiring in the substrate having a conductor layer on a surface thereof is preferably 35 μm or less, and more preferably 3 to 30 μm.

Furthermore, the substrate having a conductor layer on a surface thereof used in the present invention preferably has pretreatment performed to the conductor layer surface in order to improve adhesion with the curable resin film. A known technique can be used without particular limitation as the method of pretreatment. For example, if the conductor layer is made of copper, examples of the method include oxidation treatment methods wherein a strong alkali oxidizing solution is brought Into contact with the conductor layer surface to form a copper oxide layer onto tire conductor surface and then roughening is performed, methods of using sodium borohydride, formalin, and the like to perform reduction alter oxidizing the conductor layer surface using the previous method, methods of precipitating a plating onto the conductor layer and then roughening, methods of bringing an organic acid into contact with the conductor layer to elute the grain boundary of the copper and then roughening, methods of forming a primer layer onto the conductor layer by a thiol compound, silane compound, or the like. Of these, from the perspective of ease of maintaining die shape of the fine wiring pattern, the method of bringing an organic acid into contact with the conductor layer to elute the grain boundary of the copper and then roughening, and the method of forming a primer layer onto the conductor layer by a thiol compound, silane compound, or the like, are preferable.

Examples of the method of laminating the curable resin film formed on the supporting body onto the substrate includes methods of heat crimping onto the substrate the curable resin film formed on the supporting body on a curable resin film forming surface side, and the like.

Examples of the method of heat crimping include methods of overlaying the curable resin film formed on the supporting body so as to be in contact with the aforementioned conductor layer of the substrate, and performing heat crimping (lamination) by a pressurizer such as pressurizing laminators, presses, vacuum, laminators, vacuum presses, and roll laminator. By applying heat and pressure, the conductor layer of the substrate surface and the curable resin film can be bonded so that a void is substantially not present at the interface thereof. The curable resin film is usually laminated onto the conductor layer of the substrate in an uncured or semi-cured state.

The temperature of the heat crimping operation is usually 30 to 250° C. and preferably 70 to 200° C., the pressure to be applied is usually 1 kPa to 20 MPa and preferably 100 kPa to 10 MPa, and the time is usually 30 seconds to 5 hours and preferably 1 minute to 3 hours. Furthermore, heat crimping is preferably performed under reduced pressure in order to improve embedding properties of the wiring pattern and to suppress the generation of bubbles. The pressure of the reduced pressure to perform heat crimping is usually 100 kPa to 1 Pa, and preferably 40 kPa to 10 Pa.

### Fourth Step

The fourth step of the manufacturing method of the present invention is a step of peeling the supporting body from the cured resin film.

Note that in the manufacturing method of the present invention, if the cured laminate body where the cured resin film and supporting body are formed in this order on the supporting body, prior to or after peeling the supporting body, the via hole or through, hole that penetrates the cured resin film may be formed. The via hole or through hole are formed for connecting the conductor layers configuring the multilayer circuit board, if the laminate body containing the cured resin film and substrate (hereinafter, simply referred to as “laminated body”), obtained by the manufacturing method of the present invention is used in the multilayer circuit board. The via hole or through hole can be formed by a physical process and the like such as a drill, laser, or plasma etching for example. Of these methods, a method using a laser (carbon dioxide gas laser, excimer laser, UV-YAG laser, and the like) can form a fine via hole or through hole without reducing the properties of the cured resin layer, which is preferred. Note that prior to peeling the supporting body, if the via hole or through hole is formed using a laser in a cured resin film with a supporting body condition, a laser is preferably emitted from the supporting body side to form the via hole or through hole, and thereby, a finer via hole or through hole can be formed with a high aperture ratio (bottom diameter/top diameter).

Furthermore, in the manufacturing method of the present invention, after peeling the supporting body, a surface roughening treatment of roughening a surface of the cured resin film with an aqueous solution of permanganate may be performed. The surface roughening treatment is a treatment performed for increasing adhesion with a conductive layer formed on the cured resin film, if the laminate body obtained by the manufacturing method of the present invention is used in the multilayer circuit board.

The average surface roughness Ra of the cured resin film is preferably 0.05 μm to 0.3 μm, and more preferably 0.06 μm to 0.2 μm, and the ten point average surface roughness Rzjis is preferably 0.3 μm to 4 μm, and more preferably 0.5 μm to 2 μm. Note that in the present specification, Ra is a center line average surface roughness shown in JIS B0601-2001, and the ten point average surface roughness Rzjis is a ten point average roughness shown in Annex 1 of JIS B0601-2001.

The surface roughening treatment is not particularly limited, and examples include methods of bringing the cured resin film surface into contact with the oxidizing compound, or the like. Examples of the oxidizing compound include known compounds having oxidizing ability, such as inorganic oxidizing compounds and organic oxidizing compounds. Using inorganic oxidizing compounds or organic oxidizing compounds are particularly preferable because of the ease of controlling the average surface roughness of the cured resin film. Examples of the inorganic oxidizing compound include permanganates, chromic anhydrides, dichromates, chromates, persulfates, activated manganese dioxide, osmium tetroxide, hydrogen peroxide, periodate salts, and the like. Examples of the organic oxidizing compound include dicumyl peroxides, octanoyl peroxides, m-chloroperbenzoic acids, peracetic acids, ozones, and the like.

The method of surface roughening treating the cured resin film surface using an inorganic oxidizing compound or organic oxidizing compound is not particularly limited. An example includes a method of dissolving the oxidizing compound in a dissolvable solvent, and then bringing the prepared oxidizing compound solution into contact with the cured resin film surface. The method of bringing the oxidizing compound solution into contact with a surface of the cured resin film is not particularly limited, but examples include any method such as dipping methods of immersing the cured resin film into the oxidizing compound solution, liquid deposition methods of placing the oxidizing compound solution on the cured resin film utilizing the surface tension of the oxidizing compound solution, and spraying methods of spraying the oxidizing compound solution onto the cured resin film. By performing the surface roughening treatment, adhesion with a second layer such as a conductor layer of the cured resin film can be enhanced.

The temperature or time of bringing the oxidizing compound solution into contact with the cured resin film surface may be arbitrarily set in consideration of the concentration or type of the oxidizing compound, contacting method, and the like, but the temperature is usually 10 to 250° C., and preferably 20 to 180° C., and the time is usually 0.5 to 60 minutes, and preferably 1 to 40 minutes.

Note that after the surface roughening treatment, the cured resin film surface after the surface roughening treatment is washed with water to remove the oxidizing compound. Furthermore, if a substance that is not completely washed off with water is adhered, further washing is performed using a washing solution that can dissolve the substance, or the substance is brought into contact with a second compound to make the substance soluble in water, and then washing with water is performed. For example, if potassium permanganate aqueous solution, sodium permanganate aqueous solution, or other alkali aqueous solution is brought into contact with the cured resin film, a neutralization reduction treatment is performed using an acidic aqueous solution such as a mixture between a hydroxylamine sulfate and sulfate, and then washing with water is performed in order to remove a generated film of manganese dioxide.

Thereby, the cured resin film and the laminate body formed by forming the cured resin film on the substrate can be obtained according to the manufacturing method of the present invention, and thus the obtained cured resin film and laminated body are obtained by the manufacturing method of the present invention, and therefore, a cured resin film that effectively prevents defects such as wrinkles or bubbles, from occurring, and a laminate body provided with the cured resin film can be obtained with high productivity.

### Multilayer Circuit Board

The multilayer circuit board of the present invention is obtained by further forming a second conductor layer onto the cured resin film of the laminate body obtained by the manufacturing method of the present invention. The manufacturing method of the multilayer circuit board of the present invention will be described below.

First, a process of forming the via hole or through hole on the cured resin film is performed for the laminate body obtained by the manufacturing method of the present invention, in accordance with the aforementioned method, and then the surface roughening treatment of the cured resin film is performed.

Next, after performing the surface roughening treatment on the cured resin film of the laminate body, a conductor layer is formed on a surface of the cured resin film and an inner wall surface of the via hole or through bole. The forming method of the conductor layer is not particularly limited, but is preferably a plating method from the perspective of forming a laminate body with excellent adhesion.

The method of forming the conductor layer by a plating method is not particularly limited, and can be a method of forming a metal thin film by plating or the like onto the cured resin film, and then growing a metal layer by thick plating for example.

For example, if forming of the metal thin film is performed using electroless plating, prior to forming the metal thin film on a surface of the cured resin film, a catalyst nucleus such as silver, palladium, zinc, or cobalt is generally adhered onto the cured resin film. The method of attaching the catalyst nucleus to the cured resin film is not particularly limited, and examples include methods of immersing into a solution in which a metal compound such as silver, palladium, zinc, and cobalt, or salts or complexes thereof, for example, are dissolved into an organic solvent such as water, alcohol, or chloroform at a concentration of 0.001 to 10 wt. % (may contain acid, alkali, complexing agent, reducing agent, and the like as necessary) to reduce the metal, and the like.

The electroless plating solution used in the electroless plating method can be a known autocatalytic electroless plating solution, and the type of metal, type of reducing agent, type of complexing agent, hydrogen ion concentration, dissolved oxygen concentration, and the like that are contained in the plating solution are not particularly limited. For example, electroless copper plating solutions with a reducing agent of ammonium hypophosphite, hypophosphorous acid, ammonium borohydride, hydrazine, formalin, and the like; electroless nickel phosphorus plating solutions with a reducing agent of sodium hypophosphite; electroless nickel-boron plating solutions with a reducing agent of dimethylamine borane; electroless palladium plating solutions; electroless palladium-phosphorus plating solutions with a reducing agent of sodium hypophosphite; electroless gold plating solutions; electroless silver plating solutions; electroless nickel-cobalt-phosphorus plating solutions with a reducing agent of sodium hypophosphite; and other electroless plating solutions can be used.

After the- metal thin film is formed, the substrate surface can be brought into contact with an ant-rust, agent to perform antirust treatment. Furthermore, after the metal thin film is formed, the metal thin film may be heated to improve adhesion or the like. The heating temperature is usually 50 to 350° C., and preferably 80 to 250° C. Note that the heating can be performed under pressurized conditions. Examples of the pressurizing method include using physical pressurizing means by hot press machines, pressurized heating rolls, and the like. The pressure applied is usually 0.1 to 20 MPa, and preferably 0.5 to 10 MPa. High adhesion between the metal thin film and the cured resin film can be secured within these ranges.

A resist pattern for plating Is formed on the metal thin film formed thereby, the plating is grown by wet plating such as electrolytic plating thereon (thick plating), and then the resist is removed, and the metal thin film is etched into a pattern by etching to form a conductor layer. Therefore, the conductor layer formed by the method is usually formed from the patterned metal thin film and the plating grown on the metal thin film.

The multilayer circuit board obtained as described above is used as the substrate for manufacturing a laminate body In the manufacturing method of the present invention, laminated with the curable resin film with a supporting body, and cured to form the cured resin film (third step); and the supporting body is peeled to obtain the laminate body (fourth step); and then thereon, a conductive layer is formed and the aforementioned steps are repeated, and therefore, additional multilayering can be performed, and thereby, a desired multilayer circuit board can be obtained.

The multilayer circuit board of the present invention obtained thereby has the laminate body obtained by the manufacturing method of the present invention, and the laminate body is provided with the cured resin film (electrical insulating layer) that effectively prevents defects such as wrinkles or bubbles from occurring, and therefore, the multilayer circuit board of the present invention can be suitably used in various applications.

### EXAMPLES

The present invention is described in further detail by the examples and comparative examples below. Note that “parts” and “%” in the examples are on a weight basis unless otherwise specified. Various physical properties were measured and evaluated according to the following methods.

(1) Heating Loss of the Second Curable Resin Film and the First Curable Resin Film

The second curable resin film and the first curable resin film that were obtained were peeled from the polyethylene terephthalate film, and the total heating loss of the second curable resin film and the first curable resin film when heated to 170° C. for 15 minutes was measured using a differential thermogravimetric simultaneous measurement device (TG-DTA).

(2) Film Transportability When Dry

The shift in the lateral direction during transport of the film in the drying device 50 was measured when drying die second undried resin film and when drying the first undried resin film, and die film transportability was evaluated by die following criteria.

Evaluation Criteria

A: Shift in the lateral direction of the film is less than±1 mm.

B: Shift in the lateral direction of the film is 1 mm or greater and less than 2 mm.

C: Shift in the lateral direction of the film is 2 mm or greater.

(3) Evaluation of the Embedding Properties of the Second Curable Resin Film and the First Curable Resin Film

For the laminate substrate that was obtained, the embedding properties of the second curable resin film and the first curable resin film were evaluated by the following criteria by measuring the number of voids that have occurred when the area between the wiring of the inner layer substrate is observed by an optical microscope.

Evaluation Criteria

A: No voids occurred

B: One or more and less than 10 voids occurred

C: More than 10 voids occurred

(4) Bubbles in Curable Resin Film

For the curable resin film obtained, the presence of bubbles in the curable resin film was confirmed by observing the appearance using the naked eye, and evaluated according to the following criteria.

Evaluation Criteria

A: No bubbles

B: One or more bubbles and less than 10 bubbles

C: 10 or more bubbles

(5) Wrinkles in Curable Resin Film

For the curable resin film of the laminate body that was obtained, the presence of wrinkles on the surface of the curable resin film was confirmed by observing the appearance using the naked eye, and evaluated according to the following criteria.

Evaluation Criteria

A: Wrinkles were not observed.

B: Wrinkles were confirmed on a range of the area that is less than 10%.

C: Wrinkles were confirmed on a range of the area that is 10% or greater.

### Synthesis Example 1

As a first stage of polymerization, 35 molar parts of 5-ethylidene-bicyclo [2.2.1] hepta2-en, 0.9 molar parts of 1-hexene, 340 molar parts of anisole, and 0.005 molar parts of ruthenium 4-acetoxybenzylidene (dichloro) (4,5-dibromo1,3-dimesityl-4-imidazolin-2-ylidene) (tricyclohexylphosphine) (C1063, manufactured by Wako Pure Chemical industries) were incorporated in a nitrogen substituted pressure resistant glass reactor, and polymerization reaction was performed by stirring at 80° C. for 30 minutes to obtain a solution of a norbornene-based ring-opening polymer.

Next, as a second stage of polymerization, 45 molar parts of tetracyclo [6.5.0.1^{2,5}.0^{8,13}] trideca3,8,10,12-tetraene, 20 molar parts of bicyclo [2.2.1] hept-2-ene-5,6-dicarboxylic anhydride, 250 molar parts of anisole, and 0.01 molar parts of C1063 were added to the solution obtained in the first stage of polymerization, and polymerization reaction was performed by stirring at 80° C. for 1.5 hours to obtain a solution of a norbornene-based ring-opening polymer. For the solution, gas chromatography was measured, and it was confirmed that no monomers were substantially remaining, and the polymerization conversion rate was 99% or higher.

Next, the solution of the obtained ring-opening polymer was added to a nitrogen substituted autoclave with mixer, 0.03 molar parts of C1063 were added, and a hydrogenation reaction was performed by stirring at 150° C. at a hydrogen pressure of 7 MPa for 5 hours to obtain a solution of an alicyclic olefin polymer (1) which was a hydrogation adduct of the norbornene-based ring-opening polymer. The weight average molecular weight of the alicyclic olefin polymer (1) was 60000, the number average molecular weight was 30000, and the molecular weight distribution was 2. Furthermore, the hydrogenation ratio was 95%, and the content rate of the repeating unit having a carboxylic anhydride group was 20 mol %. The solid content concentration of the solution of the alicyclic olefin polymer (1) was 22%.

### Example 1

Preparation of the First Thermosetting Resin Composition

50 parts of a biphenyldimethylene skeleton novolak epoxy resin as the polyvalent epoxy compound (A) having a biphenyl structure (trade name “NC-3000L”, manufactured by Nippon Kayaku Co., Ltd., epoxy equivalent of 269), 50 parts of tetrakis hydroxyphenylethane type epoxy compound as the epoxy group (B) containing a trivalent or higher polyvalent glycidyl group (trade name “1031S”, manufactured by Mitsubishi Chemical Corporation, epoxy equivalent of 200, softening point of 90° C.), 30 parts (15 parts in terms of cresol novolac resin containing a triazine structure) of cresol novolak resin containing a triazine structure as the phenol resin (C) containing a triazine structure (trade name “phenolite LA-3018-50P”, propylene glycol monomethyl ether solution with a nonvolatile content of 50%, manufactured by DIC Corporation, active hydroxyl group equivalent of 154), 115.3 parts (75 parts in terms of active ester compounds) of active ester compound as the active ester compound (D) (trade name “Epiclon HPC-8000-65T”, toluene solution having a nonvolatile content of 65%, manufactured by DIC Corporation, active ester group equivalent of 223), 350 parts of silica as a filler (trade name “SC2500-SXJ”, manufactured by Admatechs), 1 part of hindered phenol antioxidant as an anti-aging agent (trade name “Irganox (registered trademark) 3114”, manufactured by BASF), and 110 parts of anisole were mixed and stirred with a planetary mixer for 3 minutes. In addition, 8.3 parts (2.5 parts in terms of 1-benzyl-2-phenylimidazole) of a solution in which 1-benzyl-2-phenylimidazoIe was 30% dissolved in anisole were mixed therein as the curing promoting agent, and stirred for with a planetary mixer for 5 minutes to obtain a first thermosetting resin composition. Incidentally, the amount of filler in the first thermosetting resin composition was 64%, calculated as solid content.

Preparation of the Second Thermosetting Resin Composition

454 parts of the solution of the alicyclic olefin polymer (1) obtained in Synthesis Example (100 parts in terms of alicyclic olefin polymer (1)), 36 parts of the polyvalent epoxy compound having a dicyclopentadiene skeleton as a curing agent (trade name “Epiclon HP7200L”, manufactured by DIC Corporation, “Epiclon” is a registered trademark), 24.5 parts of silica as an inorganic filler (trade name “Admafine SO-C1”, manufactured by Admatechs, average particle size of 0.25 μm, “Admafine” is a registered trademark), 1 part of tris (3,5-di-t-butyl-4-hydroxybenzyl)-isocyanurate as an anti-aging agent (trade name “Irganox (registered trademark) 3114”, manufactured by BASF), 5 parts of 2-[2-hydroxy-3,5-bis (α,α-dimethylbenzyl) phenyl]-2H-benzotriaole as an ultraviolet absorber, and 0.5 parts of 1-benzyl-2-phenylimidazole as a curing promoting agent were mixed with anisole, and by mixing so that the compounding agent concentration was 16%, a second thermosetting resin composition was obtained.

Forming Second Curable Resin Film

The second curable resin film was formed on a polyethylene terephthalate film using the second thermosetting resin composition obtained as described above and a polyethylene terephthalate film (supporting body, thickness 50 μm) with a release layer on the surface, using the manufacturing device illustrated in FIG. 1. Specifically, the second undried resin film with a thickness of 20 μm was formed on a polyethylene terephthalate film by continuously rolling out a polyethylene terephthalate film from a first roll 20 on which a long polyethylene terephthalate film was rolled, and continuously applying the second thermosetting resin composition using an application device 40. Furthermore, the second curable resin film with a thickness of 3.5 μm was formed on the long polyethylene terephthalate film by continuously transporting the undried resin film into a dryer 50 using a floating system to remove the anisole as a solvent, and then continuously rolling this film onto a second roller 30, as the second curable resin film.

Incidentally, the drying conditions at this time were as described below.

(Heating Zone) The heating zone was divided into four zones, configured such that the temperature increased in steps along the direction of travel of the polyethylene terephthalate film, where the lowest temperature was 30° C., and the highest temperature was 60° C.

(Drying Zone) The drying zone was divided into four zones, configured such that the temperature increased in steps along the direction of travel of the polyethylene terephthalate film, where the lowest temperature was 60° C., and the highest temperature was 90° C.

(Drying Time (Time For Passing Through Dryer 50)) 60 Seconds

(Dryer Airflow Rate) 3.5 m³/hr

Next, the first curable resin film was formed on the second curable resin film formed surface on the polyethylene terephthalate film where the second curable resin film was formed using the first thermosetting resin composition obtained as described above, using the manufacturing device illustrated in FIG. 1. Specifically, the first undried resin film with a thickness of 50 μm was formed on the polyethylene terephthalate film on which the second curable resin film was formed by continuously rolling out the polyethylene terephthalate film on which the second curable resin film was formed from a first roll 20 on which a long polyethylene terephthalate film was rolled, and continuously applying the first thermosetting resin composition using an application device 40. Furthermore, the first curable resin film with a thickness of 37.5 μm was formed on the second curable resin film on the long polyethylene terephthalate film by continuously transporting the undried resin film into a dryer 50 using a floating system to remove the anisole as a solvent, and then continuously rolling this film onto a second roller 30, as the first curable resin film. Incidentally, the drying conditions at this time were the same as during the formation of the second curable resin film. Furthermore, in the present embodiment, the transportability of the film in the drying device 50 was evaluated while drying the second undried resin film and while drying the first undried resin film in accordance with the aforementioned method. The results are shown in Table 1.

Furthermore, the total of the heating loss of the second curable resin film and the first curable resin film was measured in accordance with the aforementioned method using the film where the second curable resin film and the first curable resin film performed on the polyethylene terephthalate film that was obtained. The results are shown in Table 1.

Fabrication of Laminate Body

Next, separately from the above, on a surface of a core material obtained by impregnating a varnish containing a glass filler and an epoxy compound not containing a halogen into a glass fiber, a conductor layer with a wiring width and distance between the wires of 50 μm, with a thickness of 18 μm, and that was treated with microetching by bringing a surface thereof into contact with an organic acid, was formed onto a double-sided copper clad substrate surface with a thickness of 0.8 mm, 160 mm square (length of 160 mm, width of 160 mm) attached with copper with a wiring height (thickness) of 18 μm, to obtain an inner layer substrate.

On both surfaces of the inner layer substrate, the film obtained by forming the second curable resin film and the first curable resin film obtained as described above was cut into 150 mm squares and overlaid such that the surface on the first curable resin film side was on the inside when attached to the polyethylene terephthalate film, and then the pressure was reduced to 200 Pa and heat crimping lamination was performed at a temperature of 110° C. and a pressure of 0.1 MPa for 60 seconds using a vacuum laminator with a heat resistant rubber press plate on the top and bottom thereof The embedding properties were evaluated using the laminate substrate that was obtained, in accordance with the aforementioned method. Next, a cured resin film (electrical insulating layer) was formed by curing the second curable resin film and the first curable resin film by allowing the film to stand at room temperature for 30 minutes, and then heating at 180° C. for 30 minutes. Foaming was evaluated using the laminate substrate that was obtained, in accordance with the aforementioned method. Next, the laminate body containing the cured resin film and the inner layer substrate was obtained by peeling the supporting body from the cured resin film. Wrinkling of the cured resin film was measured using the laminate substrate that was obtained, in accordance with the aforementioned method. The results are shown in Table 1.

### Example 2

A film containing the second curable resin film and the first curable resin film on the polyethylene terephthalate film, and a laminate body were obtained by the same method as Example 1, except that the maximum temperature of the heating zone when drying the second undried resin film and the first undried resin film was changed from 60° C. to 40° C., the maximum temperature of the drying zone was changed from 90° C. to 60° C., and the drying time was changed from 60 seconds to 180 seconds (time for passing through the drying device 50).

The results are shown in Table 1.

### Example 3

A film containing the second curable resin film and the first curable resin film on the polyethylene terephthalate film, and a laminate body were obtained by the same method as Example 1, except that the maximum temperature of the heating zone when drying the second undried resin film and the first undried resin film was changed from 60° C. to 35° C. the maximum temperature of the drying zone was changed from 90° C. to 60° C., and the drying time was changed from 60 seconds to 280 seconds (time for passing through the drying device 50).

The results are shown in Table 1.

### Example 4

A film containing the second curable resin film and the first curable resin film on the polyethylene terephthalate film, and a laminate body were obtained by the same method as Example 1 , except that the maximum temperature of the drying zone was changed from 90° C. to 65° C., and the drying time was changed from 60 seconds to 50 seconds (time for passing through the drying device 50). The results are shown in Table 1.

### Example 5

A film containing the second curable resin film and the first curable resin film on the polyethylene terephthalate film, and a laminate body were obtained by the same method as Example 1, except that the maximum temperature of the heating zone when drying the second undried resin film and the first undried resin film was changed from 60° C. to 50° C., the maximum temperature of the drying zone was changed from 90° C. to 110° C., and the drying time was changed from 60 seconds to 30 seconds (time for passing through the drying device 50), and the drying air flow rate was changed from 3.5 m³/hr to 8.0 m³/hr, The results are shown in Table 1.

### Comparative Example 1

A film containing the second curable resin film and the first curable resin film on the polyethylene terephthalate film, and a laminate body were obtained by the same method as Example 1, except that the drying method was changed to the roller support method (using a configuration where the film is transported by a roller in the manufacturing device illustrated in FIG. 1), when drying the second, undried resin film and the first undried resin film. The results are shown In Table 1.

### Comparative Example 2

A film containing the second curable resin film and the first curable resin film on the polyethylene terephthalate film, and a laminate body were obtained by the same method as Example 1, except that the maximum temperature of the heating zone when drying die second undried resin film and the first undried resin film was changed from 60° C. to 70° C., the maximum temperature of the drying zone was changed from 90° C. to 110° C., and the drying time was changed from 60 seconds to 180 seconds (time for passing through the drying device 50), and the drying air flow rate was changed from 3.5 m³/hr to 11.0 m³/hr. The results are shown in Table 1.

### Comparative Example 3

A film containing the second curable resin film and the first curable resin film on the polyethylene terephthalate film, and a laminate body were obtained by the same method as Example 1, except that the maximum temperature of the heating zone when drying the second undried resin film and the first undried resin film was changed from 60° C. to 30° C., the maximum temperature of the drying zone was changed from 90° C. to 50° C., and the drying time was changed from 60 seconds to 360 seconds (time for passing through the drying device 50). The results are shown in Table 1.

TABLE 1

| | Example | | | | | Comparative Example | | |
|---|---|---|---|---|---|---|---|---|
| | 1 | 2 | 3 | 4 | | 1 | | 3 |
| Drying System | Floating System | | | | | | | |
| Maximum Temperature | 60 | 40 | 35 | 60 | 50 | 60 | 70 | 30 |
| (° C.) of Heating Zone | | | | | | | | |
| Maximum Temperature | 90 | 60 | 60 | 95 | 110 | 90 | 110 | 50 |
| of Drying Zone (° C.) | | | | | | | | |
| Drying Time (seconds) | 60 | 180 | 280 | 50 | 30 | 60 | 30 | 360 |
| Drying Air Flowrate | 3.5 | 3.5 | 3.5 | 3.5 | 8.0 | 3.5 | 11.0 | 3.5 |
| (m³/hour) | | | | | | | | |
| Heating Loss Amount of | 2.5 | 2.5 | 2.5 | 2.5 | 2.0 | 2.5 | 0.3 | 8.0 |
| Curable Resin Film (%) | | | | | | | | |
| Film Transportability | A | A | A | A | B | A | C | A |
| During Drying | | | | | | | | |
| Embedding Properties | A | A | A | A | A | | | |

The results shown in Table 1 show that excellent film transportability when dry and excellent wiring embedding properties can be achieved by the manufacturing method of the present invention, and therefore a cured resin film that effectively prevents the occurrence of defects such as winkling and foaming, and that has high productivity, as well as a laminate body containing this resin film can be obtained (Examples 1 to 5).

On the other hand, if drying of the undried resin film is performed by the roller support method, wrinkles will occur in the cured resin film that is obtained, and the reliability as an electrical insulating layer will be inferior (Comparative Example 1).

Furthermore, it is the drying conditions of the undried resin film are set high, such that the heating loss of the second curable resin film and the first curable resin film is less than 0.5 weight %, wrinkling will occur in the cured resin film that is obtained, and the reliability as an electrical insulating layer will be inferior, and furthermore, the film transportability when dry will be reduced and productivity will be poor, and furthermore, the wiring and bedding properties will be inferior, and as a result, bubbles will occur in the cured resin film, that is obtained (Comparative Example 2).

Furthermore, if the drying conditions of the undried resin film are set to be low, the heating loss of the second curable resin film and the first curable resin film will exceed 7 wt. %, bubbles will occur in the cured resin film that is obtained as a result of residual solvent or the like, and the reliability as an electrical insulating layer will be inferior. (Comparative Example 3).

### REFERENCE NUMERALS

10 Pre-dried resin film with a supporting body
10a Curable resin film with a supporting body
20 First roller
30 Second roller
40 Coating device
50 Drying device
60 Hot air outlet

1. A manufacturing method of a cured resin film, comprising:
a first operation of forming on a supporting body an undried resin film formed from a thermosetting resin composition containing a curable resin and solvent;
a second operation of drying the undried resin film formed on the supporting body by transporting in a floating system in a drying device in a condition formed on the supporting body to obtain a curable resin film with a heating loss amount of 0.5 to 7 wt. %;
a third operation of thermal curing the curable resin film to obtain a cured resin film; and
a fourth operation of peeling the supporting body from the cured resin film.

2. The manufacturing method of a cured resin film according to claim 1, wherein in the second operation, drying is performed by transporting the undried resin film in a condition formed on the supporting body in a floating system in a drying device provided with a heating zone set at 30 to 60° C., and a drying zone set at a higher temperature than the heating zone in this order,
the drying time of the undried resin film is set to 30 to 300 seconds, and
the drying air flowrate during drying is set at 0.5 to 7 m³/hour.

3. The manufacturing method of a cured resin film according to claim 2, wherein the heating zone and drying zone are divided into a plurality of regions, and the temperature of each zone is set to a temperature that gradually increases based the advancement of the undried resin film.

4. The manufacturing method of a cured resin film according to claim 1, wherein a film provided with a release layer on a surface is used as the supporting body.

5. The manufacturing method according to claim 1, wherein the amount of the solvent in the thermosetting resin composition is 5 to 40 wt. %.

6. The manufacturing method of the cured resin film according to claim 1,
wherein the thermosetting resin composition further contains an inorganic filler, and the content ratio of the inorganic filler in the thermosetting resin composition is 60 wt. % or greater, calculated as solid content.

7. The manufacturing method of the cured resin film according to claim 1, further comprising:
a second curable resin film forming operation of forming on a supporting body a second curable resin film containing a second curable resin that is different from the aforementioned curable resin, prior to the first operation; wherein
in the first operation, the undried resin film is formed on the second curable resin film formed on the supporting body.

8. The manufacturing method of the cured resin film according to claim 7, wherein the second curable resin film forming operation, further comprises:
a an operation of forming on the supporting body the second undried resin film formed from a second thermosetting resin composition containing the second curable resin and solvent; and
a an operation of drying the second undried resin film formed on the supporting body by transporting in a floating system in a drying device In a condition formed on the supporting body to obtain the second curable resin film with a heating loss amount of 0.5 to 7 wt. %.

9. A laminate body, comprising a cured resin film obtained by a manufacturing method of a cured resin film, comprising:
a first operation of forming on a supporting body an undried resin film formed from a thermosetting resin composition containing a curable resin and solvent;
a second operation of drying the undried resin film formed on the supporting body by transporting in a floating system in a drying device in a condition formed on the supporting body to obtain a curable resin film with a heating loss amount of 0.5 to 7 wt. %;
a third operation of thermal curing the curable resin film to obtain a cured resin film; and
a fourth operation of peeling the supporting body from the cured resin film, and a substrate.
